(19) United States
(12) Patent Application Publication
(10) Pub. No.: US 2008/0014000 A1
(43) Pub. Date: Jan. 17, 2008

(54) IMAGE PROCESSING APPARATUS

(75) Inventors: TAKASHI KUWATA, Shizuoka-ken (JP); Masanobu Kanoto, Shizuoka-ken (JP); Yasuyoshi Hayakawa, Shizuoka-ken (JP); Masao Amano, Shizuoka-ken (JP); Kazuhide Kudo, Shizuoka-ken (JP); Masayoshi Fukatsu, Shizuoka-ken (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/774,241

(22) Filed: Jul. 6, 2007

Related U.S. Application Data
(62) Division of application No. 10/869,941, filed on Jun. 18, 2004, now Pat. No. 7,267,338.

(30) Foreign Application Priority Data
Jun. 20, 2003 (JP) 2003-175983

(51) Int. Cl. G03G 15/00

(52) U.S. Cl. 399/407; 399/405

(57) ABSTRACT

An image processing apparatus ejects the sheet to witch image processing unit perform to an ejection tray or a staple stacker by a pair of ejection rollers and the like. A sheet path for guiding the sheet to the ejection rollers is opened and closed in conjunction with slide movement of the ejection tray when the ejection tray is attached to a main body of the apparatus, and the sheet path is opened and closed in conjunction with the slide movement of a staple stacker when the staple stacker is attached to the main body of the apparatus.

### BACKGROUND OF THE INVENTION

1. Field of the Invention

The present invention relates to an image processing apparatus, such as a copying machine, a printer, and a scanner, which performs image processing to a sheet in an image processing unit.

2. Description of the Related Art

FIG. 12 is a principal sectional view of a conventional disk-top type of small copying machine, and FIG. 13 shows an outer appearance of the copying machine.

In FIG. 12, reference numeral 270 designate a main body of an image forming unit, reference numeral 554 designates an image reading unit, reference numeral 551 designates an automatic document feeder (ADF), reference numeral 552 designates a document loading tray, and reference numeral 553 designates a document load glass. In the main body of the image forming unit, it is necessary to change Face Down (FD) ejection in order to response digitalization and continuous ejection page alignment, so that a sheet reverse mechanism is provided near an ejection unit.

In FIG. 12, in order to reverse the sheet which has passed through a fixing device, the sheet reverse mechanism includes an FD/FU switching flapper 501, a pair of reverse feed rollers 502a and 502b, reverse feed paths 504a and 504b, an AU feed path 505, a pair of ejection rollers 503a and 503b, a reverse flapper 506, and an ejection tray 275. The FD/FU flapper 501 properly changes Face Up (FU) and Face Down (FD).

In the above-described configuration, when the document loaded on the document loading tray 552 or the document load glass 553 of the ADF 551 is copied, the copied document is ejected in a face up manner from the pair of ejection rollers 503a and 503b to a loading tray 505 provided on a side face of the main body 270. In the conventional copying machine, a copying state can be instantly recognized and a height H1 of the document load table of the image reading apparatus shown in FIG. 13 can be lowered, because the ejection unit is provided on not an upper portion but the side face.

In disposing of a paper jam generated in the reverse feed path 504b, the reverse feed path 504b is opened by integrating the paper ejection tray 505, a sidewall 207a of the main body of the image forming apparatus, and a feed guide 502c forming the reverse feed path 504b to be rotated about a rotation shaft 555 toward a direction of an arrow J. For example, a configuration in which the paper ejection tray and the feed guide forming the feed path are integrated and rotated to open the feed path is disclosed in Japanese Patent Application Laid-Open (JP-A) No. 06-016279.

The configuration in which the paper ejection tray is rotated about an axis in a vertical direction and a guide forming the feed path of the sheet is moved in conjunction with the rotation of the paper ejection tray is disclosed in JP-A No. 11-143156. The configuration in which a sorter is slidably moved is disclosed in Japanese Utility Model Application Laid-Open (JP-U) No. 58-152642.

Sometimes a post-processing device for performing post-processing such as sorting and stapling to the ejected sheets is attached to a main body of an image forming apparatus instead of the paper ejection tray which receives the sheet ejected from the main body of the image forming apparatus. It is desirable that the paper ejection tray and the post-processing device are selectively attached to the main body of the apparatus such that the apparatus in which the loading tray is attached can be provided for a user for whom the post-processing is not required and such that the apparatus in which the post-processing device is attached can be provided for the user for whom the post-processing is required. In JP-A No. 61-119562, it is described that a mode in which the paper ejection tray is attached to the main body of the apparatus is equal to the mode in which the post-processing device is attached to the main body of the apparatus.

In the prior art shown in FIG. 13 (JP-A No. 06-016279), when the feed path guide 504c and the paper ejection tray 505 are integrally rotated in order to perform the jam disposal generated in the reverse feed path 504b, there is a fear that the sheet loaded on the paper ejection tray 505 falls down from an end portion 505a side of the paper ejection tray 505. When a capacity of the paper ejection tray is largely increased, because the user is required to operate the paper ejection tray having a heavy weight in which the many sheets are loaded in order to perform the jam disposal, operability becomes worse.

In the configuration disclosed in JP-A No. 11-143156, in which the paper ejection tray is rotated about the rotation axis extending in the vertical direction and the feed guide forming the feed path of the sheet is moved in conjunction with the rotation of the paper ejection tray, the rotation axis of the paper ejection tray is provided on one end side in the vertical direction with respect to the ejection direction of the sheet. It is necessary to rotate the paper ejection tray to about 90° in order to sufficiently open the feed path, so that a space for the rotation of the paper ejection tray is largely required in the side direction of the image forming apparatus. Therefore, a floor space required for the image forming apparatus is large.

The configuration in which the sorter is slidably moved is disclosed in JP-U No. 58-152642. However, after the user slides the sorter, the user is required to perform the operation for opening the feed path as the further additional operation, so that the operability is worse.

Further, the configuration in which the paper ejection tray and the post-processing device are selectively attached to the main body of the apparatus is not disclosed in any above-described reference which describes the prior art.

On the other hand, in the configuration described in JP-A No. 61-119562, the paper ejection tray and the post-processing device are selectively attached to the main body of the apparatus. However, in this publication, there is no disclosure concerning the configuration which disposes of the jam generated in the feed path led to the sheet ejection unit of the main body of the apparatus.

### SUMMARY OF THE INVENTION

In view of the foregoing, it is an object of the invention to improve operability in disposing of a jam generated in a sheet feed path in a sheet processing device in which a ejection tray and a post-processing device can be selectively attached to the main body of the apparatus.

In order to achieve the above-described object, an image processing apparatus of the invention comprises: a sheet supply unit which supplies a sheet; an image processing unit which performs image processing to the sheet supplied by the sheet supply unit; a sheet feed path which guides the sheet in which the image processing is performed by the image processing unit; a sheet ejection unit which ejects the sheet guided by the sheet feed path, the sheet ejection unit ejecting the sheet to an ejection tray or a post-processing device for performing post-processing to the sheet, the ejection tray and the post-processing device being selectively attached to an apparatus main body; and a support unit which slidably supports the post-processing device attached to the apparatus main body while slidably supporting the ejection tray attached to the apparatus main body, wherein the sheet feed path is opened and closed in conjunction with the slide movement of the ejection tray when the ejection tray is attached to the apparatus main body, and the sheet feed path is opened and closed in conjunction with the slide movement of the post-processing device when the post-processing device is attached to the apparatus main body.

### BRIEF DESCRIPTION OF THE DRAWINGS

FIG. 1 is a schematic sectional view for explaining an image forming apparatus;

FIG. 2 is an explanatory view of a sheet feed state when a sheet is ejected to an ejection tray;

FIG. 3 is an explanatory view of a state in which the ejection tray is attached;

FIG. 4 is an explanatory view of the state in which the ejection tray has been drawn in jam disposal or the like;

FIG. 5 is an explanatory view of the state in which the ejection tray is pushed;

FIG. 6 is an explanatory view of the state in which the ejection tray has been detached;

FIG. 7 is an explanatory view of the state in which the standard ejection tray is detached;

FIG. 8 is a perspective view of the image forming apparatus in which the ejection tray has been detached;

FIG. 9 is an explanatory view in which a staple stacker which can align a plurality of sheets to perform stapling processing is attached to the image forming apparatus;

FIG. 10 is an explanatory view of the state in which the staple stacker is drawn from a main body of the image forming apparatus in order to perform the jam disposal;

FIG. 11 is an explanatory view of the state in which a double-sided feed unit is drawn out;

FIG. 12 is a sectional view for explaining the conventional disk-top type of copying machine; and

FIG. 13 is a perspective view explaining the conventional disk-top type of copying machine.

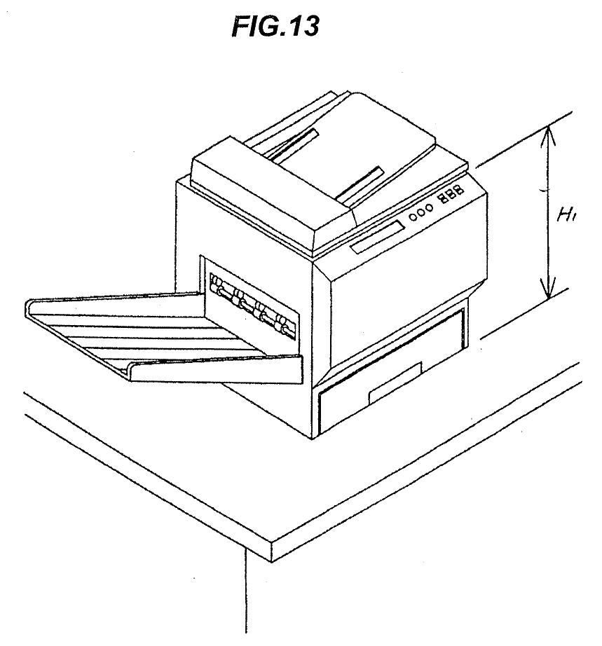

### DESCRIPTION OF THE PREFERRED EMBODIMENT

A copying machine will be illustratively described as an image processing apparatus according to an embodiment of the invention.

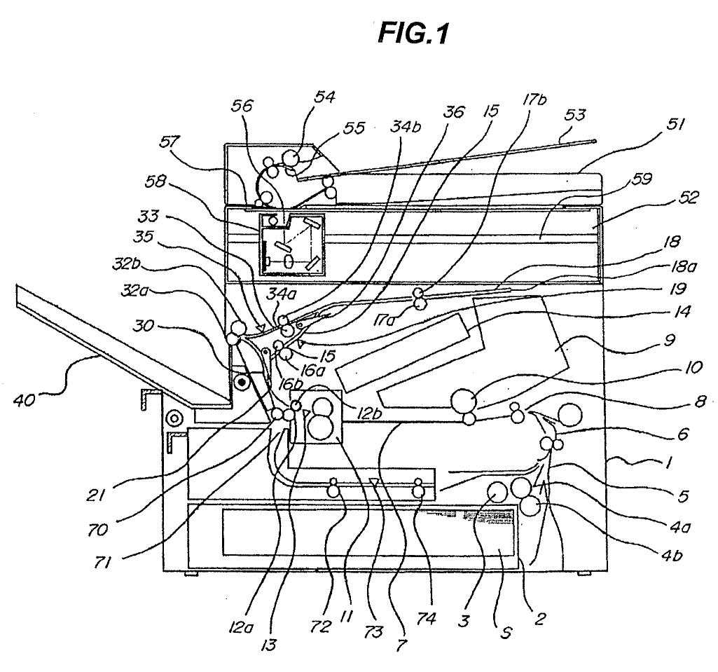

FIGS. 1 to 6 show the embodiment of the invention. FIG. 1 is a schematic sectional view for explaining the image forming apparatus which includes image forming means for forming the image in the sheet by electrophotography as the image processing unit.

[Overall Configuration]

A configuration of the image forming apparatus will be described. In FIG. 1, reference numeral 1 designates a printer including an image reading unit. A supply cassette 2 constituting a sheet supply unit, a supply roller 3 which delivers a sheet from the supply cassette 2, and separating and feeding rollers 4a and 4b which separate the delivered sheet one by one are arranged in a lower portion of the printer 1.

The sheet delivered from the sheet supply unit is fed to an image forming unit through feed paths 5, 6, and 7, resist rollers 8, and the like. The image forming unit includes an image forming process unit (hereinafter referred to as “cartridge”) 9 having an image forming drum 10 and the like. In the embodiment, the image is exposed from a scanner 14 to the image forming drum 10, the toner image is formed by the well-known electrophotography, and the toner image is transferred to the fed sheet.

The sheet in which the image has been formed is heated and pressurized with a heating and fixing device 11 to fix the toner image, and then the sheet is ejected onto an ejection tray 40 serving as an ejection unit by post-fixing ejection rollers 12a and 12b and an upper ejection roller 32a and a lower ejection roller 32b. The upper ejection roller 32a and the lower ejection roller 32b constitute a sheet ejection unit.

The image reading unit is arranged in an upper portion of the printer 1. As shown in FIG. 1, the image reading unit includes a scanner unit 52 and an ADF (Automatic Document Feeder) 51. The ADF 51 is one which optically reads information described in a document in such a manner that the plurality of documents loaded on a document loading tray 53 are separated and fed one by one by a supply roller 54 and a separating pad 55 and the document passes through a document reading position 56. The ADF 51 can be opened backward about a hinge (not shown) located at the back of the apparatus, and the ADF is opened in the case where the document is placed on a document table glass 57.

A normal scanner unit is used as the scanner unit 52, in which an optical carriage 58 reads the information described in the document placed on the document table glass 57 while laterally scanning the document along a guide shaft 59 to perform photoelectric conversion by a CCD. When the ADF 51 reads the document, the optical carriage 58 is stopped at a predetermined position to read the document which is being fed. The detail description of the scanner unit will be omitted.

[Sheet Conveying Path]

In the embodiment, two sheet conveying paths are provided in order to eject the sheet to the ejection tray 40. One of the two sheet conveying paths is a first sheet conveying path 15, in which the sheet is conveyed to above the scanner 14 in a switchback manner by the pair of post-fixing ejection rollers 12a and 12b and the sheet is reversely conveyed and ejected. The other is a second sheet conveying path 30, in which the sheet is directly ejected from the heating and fixing device 11 to the ejection tray 40.

A change of the sheet conveying path to the sheet conveying path 15 is switched by an FD/FU flapper 21 provided on a downstream side in a sheet conveying direction of the pair of post-fixing ejection rollers 12a and 12b (hereinafter simply referred to as “downstream side”). A pair of merging rollers 16a and 16b is provided at an intermediate portion of the first feed path which is located on the downstream side of the flapper 21, and a pair of reverse rollers 17a and 17b is provided above the image forming unit.

The pair of reverse rollers 17a and 17b has the configuration which can reverse the sheet conveying direction in order to feed the sheet to a third sheet conveying path 33 described later. A drawing feed path 18 is formed on the further downstream side of the pair of reverse rollers 17a and 17b, and an end portion 18a of the drawing conveying path 18 has a shape of the rounded conveying path such that a front end of the sheet does not pass through above the cartridge 9 to go outside the apparatus. A sheet detector 19 is provided in the intermediate portion of the first sheet conveying path 15.

The second sheet conveying path 30 which directly ejects the sheet to the ejection tray 40 is switched by the FD/FU flapper 21. In the second sheet conveying path, the sheet is ejected to the ejection tray 40 through the pair of the upper ejection roller 32a and the lower ejection roller 32b. In this case, face-up ejection is performed.

Further, the third sheet conveying path 33 which connects between the pair of reverse rollers 17a and 17b and the pair of the upper ejection roller 32a and the lower ejection roller 32b is provided, and a pair of convey rollers 34a and 34b and a sheet detector 35 are provided in the intermediate portion of the third sheet conveying path 33.

A reverse flapper 36 is provided in front of the pair of reverse rollers 17a and 17b and in the vicinity of a merging portion of the first sheet conveying path 15 and the third sheet conveying path 33. The reverse flapper 36 is always biased toward the side in which the first sheet conveying path 15 is closed. It is also possible that the reverse flapper 36 has the configuration in which biasing force is lightly set and the reverse flapper 36 is pushed out to be opened by convey force of the sheet, or it is also possible that the reverse flapper 36 has the configuration in which the sheet conveying paths are switched at certain timing by a solenoid or the like. When the sheet is ejected to the ejection tray 40 through the first sheet conveying path 15 and the third sheet conveying path 33, the face down ejection is performed.

With reference to the reverse timing, for example, the front end or the rear end of the sheet which is running on the first sheet conveying path 15 is detected by the sheet detector 19, and the pair of reverse rollers 17a and 17b is reversed at the time when the rear end of the sheet passes through the flapper 21 by a predetermined amount. Then, the rear end of the sheet at that time is led to the third sheet conveying path, and delivery and receipt are performed between the pair of convey rollers 34a and 34b by the predetermined amount or for a predetermined time interval. Then, the sheet is ejected to the ejection tray 40 through the pair of the upper ejection roller 32a and the lower ejection roller 32b.

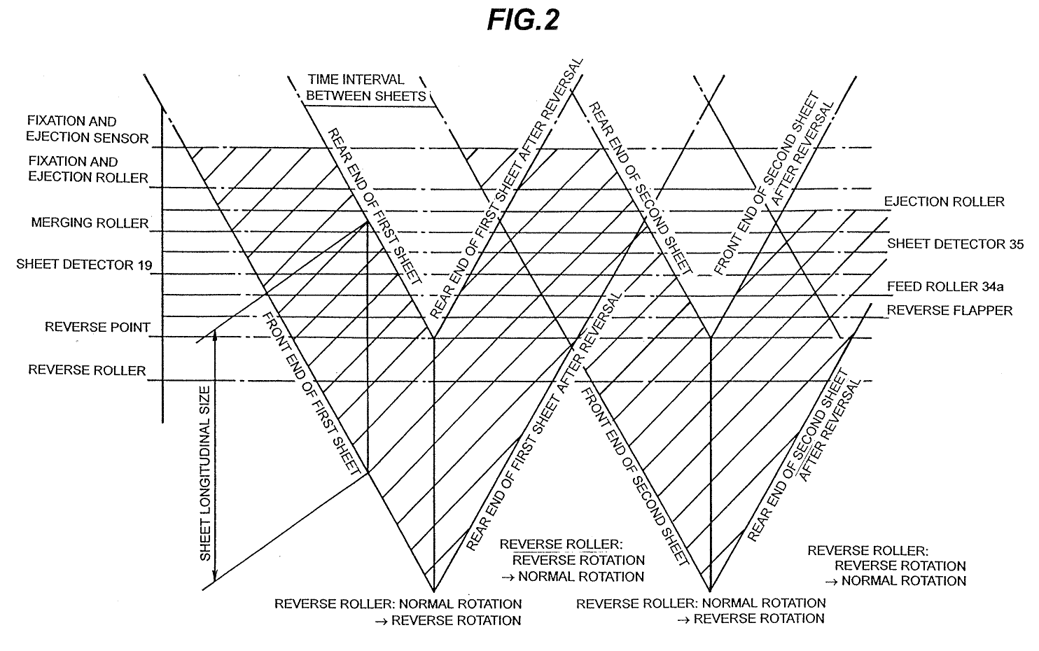

FIG. 2 is an explanatory view of a sheet conveying state when the sheet is ejected to the ejection tray 40. A sheet existing area is hatched in the range of the post-fixing ejection rollers 12a to the upper ejection roller 32a.

As can be seen from FIG. 2, the sheet is turns around at the time when the rear end of the sheet runs on by the predetermined amount after passing through the reverse flapper 36, the sheet enters the third sheet conveying path 33 to pass through the pair of feed rollers 34a and 34b and the pair of the upper ejection roller 32a and the lower ejection roller 32b, and then the sheet is ejected.

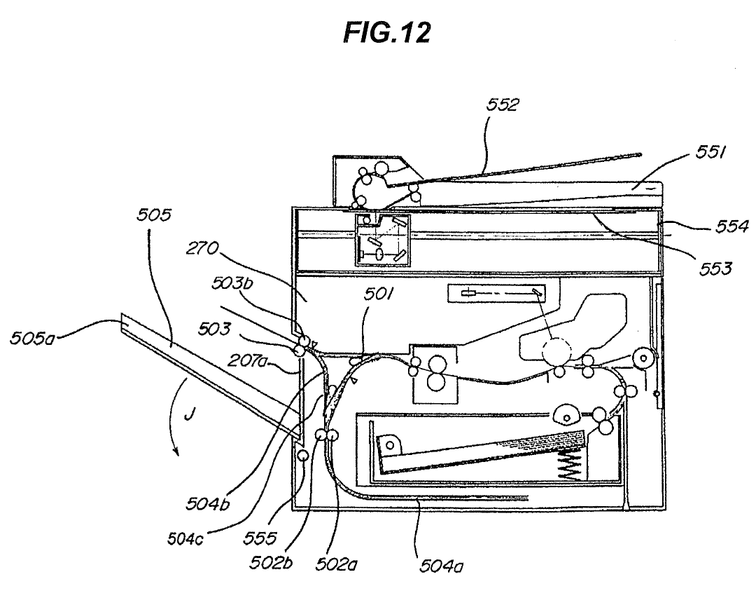

As described above, the first sheet conveying path 15 serving as the switchback conveying path is arranged above the image forming unit, and the sheet supply unit is arranged below the image forming unit. Therefore, while sheet ejection and load capacity can be increased, a supply cassette area can be enlarged. When compared to the conventional configuration shown in FIG. 12 in which the sheet reverse mechanism unit is provided on the side of the fixing device and the sheet reverse mechanism unit is rounded toward the lower portion of the apparatus, extensibility such as double-sided support and a feed option is improved while a width of the apparatus can be reduced and a height of the apparatus can be lowered.

Then, the configuration in which a double-sided conveying path provided in the lower portion of the printer 1 is arranged will be described. A double-sided pressurizing roller 70 is provided on the downstream side of the heating and fixing device 11 so as to form a nip with the post-fixing ejection roller 12a. A double-sided conveying path 71 is led to downward from the nip, and a pair of double-sided first conveying rollers 72, a pair of double-sided second conveying rollers 74, and a double-sided sheet sensor 73 are provided along the double-sided feed path 71. Then the double-sided path 71 merges with the feed path 6 again.

The sheet is temporarily led to the first sheet conveying path 15 by the FD/FU flapper 21. After the rear end of the sheet passes through the pair of post-fixing ejection rollers 12a and 12b by the predetermined amount, the pair of merging rollers 16a and 16b and the pair of reverse rollers 17a and 17b are reversed to feed the sheet to the double-sided conveying path 71. The double-sided reversal is performed at the time when the front end or the rear end of the sheet is detected by a fixation and ejection sensor 13. Then the sheet which enters the double-sided conveying path 71 is fed to the feed path 6 again at predetermined timing.

[Slide Configuration of Ejection Tray, and Opening and Closing Configuration of Second Sheet Conveying Path]

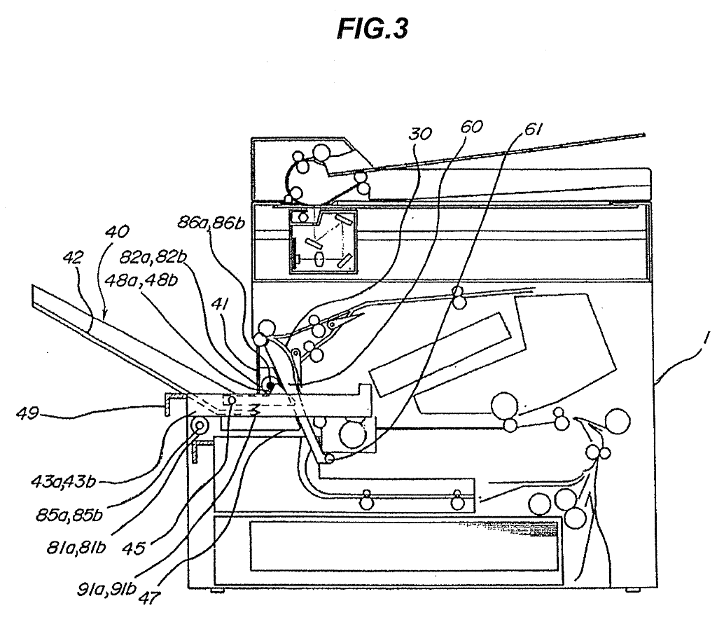

In the image forming apparatus of the embodiment, in order to simplify jam disposal and the like in the second sheet conveying path 30 which directly ejects the sheet to the ejection tray 40, while the ejection tray is slidably formed, the second sheet conveying path 30 is formed so as to be openable and closable in conjunction with the ejection tray 30. Then, a slide moving mechanism of the ejection tray 40 and an opening and closing configuration of the second sheet conveying path 30 will be described referring to FIGS. 3 to 6.

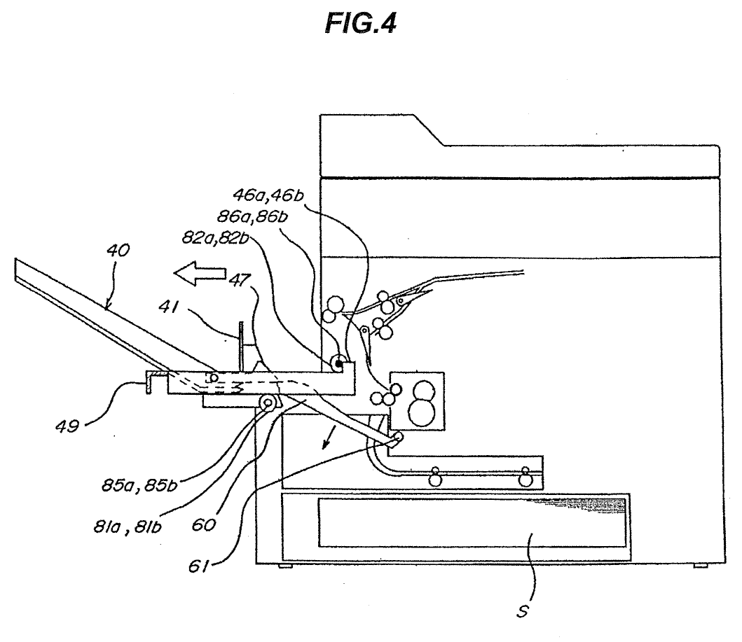

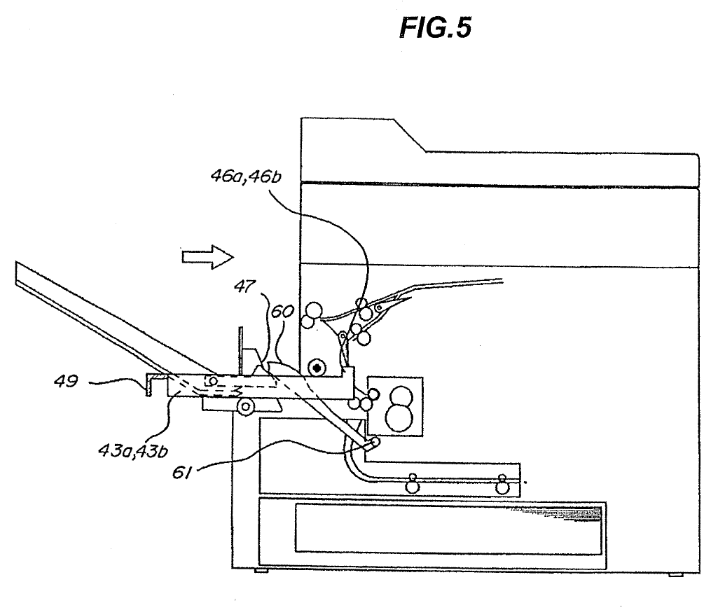

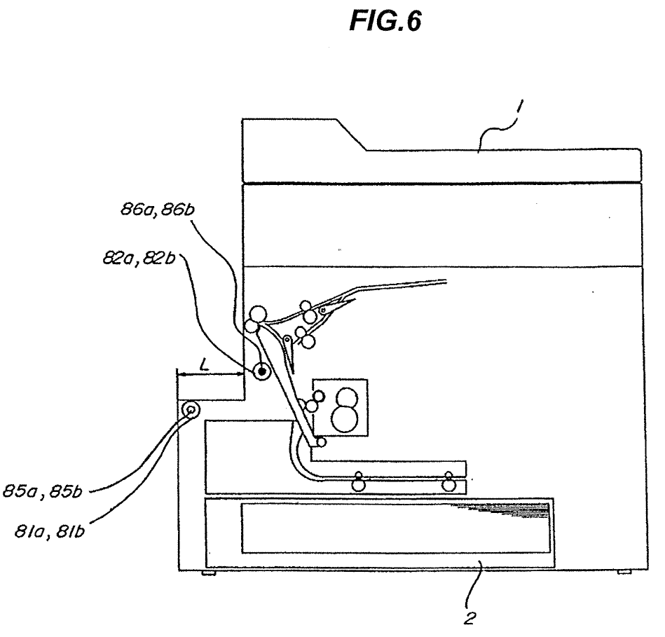

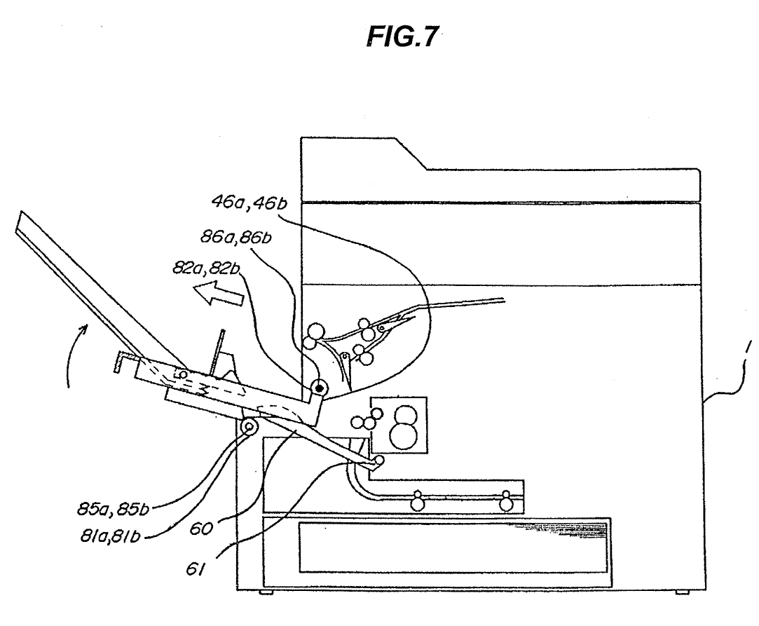

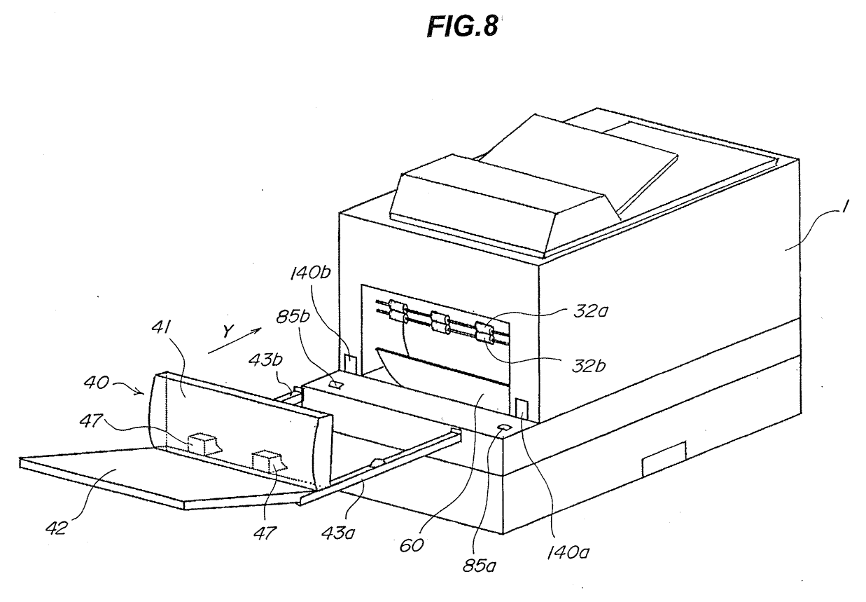

FIG. 3 is an explanatory view of a state in which the ejection tray is attached, FIG. 4 is an explanatory view of a state in which the ejection tray has been drawn in the jam disposal or the like, FIG. 5 is an explanatory view of a state in which the ejection tray is pushed, FIG. 6 is an explanatory view of a state in which the ejection tray has been detached, FIG. 7 is an explanatory view of a state in which the standard ejection tray is detached, and FIG. 8 is a perspective view of the image forming apparatus in which the ejection tray has been detached.

As mentioned above, the second sheet conveying path 30 is the sheet path located between the pair of post-fixing ejection rollers 12a and 12b and the pair of the upper ejection roller 32a and the lower ejection roller 32b.

The case in which the front end of a sheet S in which the image has been recorded is jammed in the second sheet conveying path 30 will be described here.

The ejection tray 40 shown in FIG. 3 includes a load wall 41, a tray 42, a front rail 43a which is fixed to the front side (frontal side of FIG. 3) of the tray 42, and a rear rail 43b which is fixed to the rear side (far side of FIG. 3) of the tray 42. A front latch 48a and a rear latch 48b are provided in the front rail 43a and the rear rail 43b, respectively. The front latch 48a and the rear latch 48b are rotatable about a rotation center 45, and the front latch 48a and the rear latch 48b are biased in a counterclockwise direction of FIG. 3 by springs 91a and 91b. Movements of the front rail 43a and the rear rail 43b are controlled in such a manner that the front latch 48a and the rear latch 48b are locked by latching onto roller shafts 86a and 86b, and the front rail 43a and the rear rail 43b become movable by releasing the lock. A flip-up member 47 is provided in the ejection tray 40.

The front rail 43a and the rear rail 43b are provided along a movement direction of the ejection tray 40 while formed in a rod shape. The front rail 43a and the rear rail 43b intrude into the printer 1, and the front rail 43a and the rear rail 43b are slidably supported by rollers 81a and 82a and rollers 81b and 82b. The rollers 81a and 82a are of a support unit attached to a front frame of a main body of the apparatus, and the rollers 81b and 82b are attached to a rear frame. Namely, the rollers 81a, 82a, 81b, and 82b support the ejection tray 40 such that the ejection tray 40 can horizontally slide. The front rail 43a and the rear rail 43b, which are of the supported member supported by the rollers 81a, 82a, 81b, and 82b, abut on the rollers 81a, 82a, 81b, and 82b. The front rail 43a and the rear rail 43b become guide members which guide the slide movement of the ejection tray 40. The rollers 81a and 82a are journaled in shafts 85a and 86a provided in the front frame of the main body of the printer 1, and the rollers 81b and 82b are journaled in shafts 85b and 86b provided in the rear frame.

In the embodiment, the front rail 43a and the rear rail 43b are also used as the frame of ejection tray 40, and frame strength of the ejection tray 40 is increased by the front rail 43a and the rear rail 43b. The ejection tray 40 overhangs onto the left side of FIG. 3 with respect to the main body of the apparatus to generate moment in the counterclockwise direction about the lower rollers 81a and 81b while the ejection tray is attached, so that the front rail 43a and the rear rail 43b are supported by the lower rollers 81a and 81b and the upper rollers 82a and 82b.

A large load is applied to the rollers and the shaft, because many sheets ejected from the image forming apparatus are loaded on the ejection tray 40. Particularly, in the jam disposal of the second sheet conveying path 30 while the many sheets are loaded on the ejection tray 40, the load is significantly applied to the rollers and the shaft when the ejection tray 40 is caused to slide.

In the embodiment, as shown in FIG. 6, the printer 6 has the shape in which the sheet supply unit in which the supply cassette 2 and the like are arranged is laterally protruded (toward the left side of FIG. 6) from the sheet ejection unit which is arranged above the sheet supply unit and formed by the pair of the upper ejection roller 32a and the lower ejection roller 32b. Namely, the sheet ejection unit is formed to be retreated toward the main body from the sheet supply unit. The shafts 85a and 85b and the rollers 81a and 81b which receive the load of the rails 43a and 43b are arranged above the sheet supply unit in an interval L where the sheet ejection unit is protruded from the sheet supply unit. The width of the apparatus can be decreased by the above-described configuration, when compared to the conventional configuration shown in FIG. 12 in which the sheet reverse mechanism unit is provided on the side of the fixing device and the sheet reverse mechanism unit is rounded toward the lower portion of the apparatus.

Therefore, the position receiving the load of the ejection tray 40 is located above the end portion of the sheet supply unit. In the state in which the sheets are loaded on the tray 42 to which the maximum load is applied and the ejection tray 40 is drawn to the left side in order to perform the jam disposal as shown in FIG. 4, the load of the ejection tray 40 is applied downward to the shafts 85a and 85b, and the load of the ejection tray 40 is applied upward to the shafts 86a and 86b.

In the embodiment, in order that the end portions of the frame in the vertical direction in the interval L where the sheet supply unit is protruded from the image forming apparatus and at the right and left ends of L in FIG. 6 maintain the sufficient strength, i.e. the frame portions in which the shafts 85a and 85b and the shafts 86a and 86b are provided at the position receiving the load maintain the sufficient strength, the frame above the sheet supply unit has high mechanical strength because the frame is made of sheet metal and formed by a drawing shape or a bending shape.

Thus, since the load of the drawable ejection tray 40 is supported by the frame portions having the sufficient strength, the position which receives the load becomes optimum and the sufficient strength is obtained.

Since the sheet ejection unit is retreated by the width L toward the inside of the main body from the sheet supply unit, the ejection tray 40 can overlap with the image forming apparatus by the retreated length L. Therefore, the width of the apparatus can be decreased.

An FU guide 60 forming the guide outside the second sheet conveying path 30 generates the moment in the counterclockwise direction of FIG. 3 about a rotation center 61 by deadweight. The FU guide 60 serving as the sheet guide is controlled at the position shown in FIG. 3 in such a manner that the flip-up member 47 serving as an abutting unit provided on the ejection tray 40 abuts on the FU guide 60.

When a user performs the jam disposal of the sheet S jammed in the second sheet conveying path 30, as shown in FIG. 4, the user puts user's hand on a handle 49 of the ejection tray 40 to draw the ejection tray 40 toward the left side.

As shown in FIG. 4, the front latch 48a and the rear latch 48b are rotated clockwise by drawing the ejection tray 40 to be unlocked from the roller shafts 86a and 86b, and the ejection tray 40 slides toward the left side (arrow direction). In the slide operation, the ejection tray 40 can be drawn up to the range where stopper portions 46a and 46b provided at the end portions of the front and rear rails 43a and 43b abut on shaft portions of the rollers 82a and 82b.

As shown in FIG. 4, in conjunction with the slide operation of the ejection tray 40, the flip-up member 47 is also retreated toward the left side to rotate the FU guide 60 in the counterclockwise direction about the rotation center 61 by the deadweight, which allows the second sheet conveying path 30 to be sufficiently released. Therefore, the user can access the sheet S.

When the user finishes the jam disposal of the sheet S, as shown in FIG. 5, the user puts user's hand on the handle 49 to slide the ejection tray 40 toward the right side. Therefore, the flip-up member 47 abuts on the FU guide 60 to rotate the FU guide 60 clockwise, and the ejection tray 40 slides to the position where the ejection tray 40 is latched and forms the second sheet conveying path 30.

The second sheet conveying path 30 is opened and closed in conjunction with the slide operation of the ejection tray 40 by the above-described configuration, so that the user can easily perform the jam disposal of the sheet.

Although the configuration in which the FU guide 60 is rotated by the deadweight in conjunction with the slide operation of the ejection tray 40 in the left direction of FIG. 4 has been shown as an example in the embodiment, it is also possible that the FU guide 60 is rotated by the spring which biases the FU guide 60 toward the direction in which the sheet conveying path is opened.

According to the configuration of the above-described embodiment, the apparatus having ease of use, excellent option extensibility, and less installation area can be provided.

[Attachment and Detachment of Ejection Tray]

In the image forming apparatus of the embodiment, the ejection tray 40 can be detached from the main body of the image forming apparatus and a post-processing device can be attached instead of the ejection tray 40. Namely, in the image forming apparatus, the ejection tray 40 and the post-processing process can be selectively attached.

The operation in detaching the ejection tray 40 from the main body of the apparatus will be described referring to FIG. 7.

The ejection tray 40 is slid to the position where the ejection tray 40 can be slid in maximum, namely, as shown in FIG. 4, the ejection tray 40 is slid until the stopper portions 46a and 46b provided in the end portions of the rails abut on the shafts 86a and 86b.

Then, as shown in FIG. 7, the ejection tray 40 is pulled out toward the arrow direction in such a manner that the ejection tray 40 is inclined toward the clockwise direction to be rotated to an angle in which the stopper portions 46a and 46b do not abut on the shafts 86a and 86b.

FIG. 8 is a perspective view of the image forming apparatus in which the ejection tray has been detached. When the detached ejection tray 40 is attached to the main body of the image forming apparatus, the front ends of the rails 43a and 43b provided in the ejection tray 40 are inserted into openings 140a and 140b made in the main body of the image forming apparatus, and the ejection tray 40 is inserted toward the direction of an arrow Y which is the attaching direction to the main body of the apparatus.

[Slide Configuration of Staple Stacker, and Opening and Closing Configuration of Second Sheet Conveying Path]

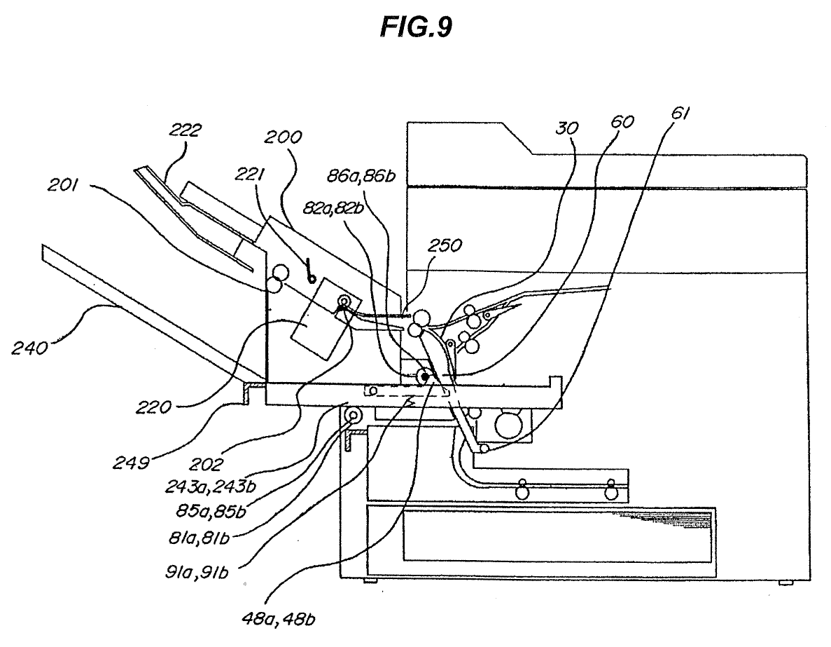

FIG. 9 is an explanatory view in which a staple stacker 200 (post-processing device) which can align a plurality of sheets to perform stapling processing is attached to the main body of the image forming apparatus.

The staple stacker 200 includes a stapler 220 serving as stapling means, a paddle 221 serving as sheet conveying direction aligning means, a jogger 222 which performs alignment in the direction orthogonal to the conveying direction, a pair of inlet rollers 201, a pair of ejection rollers 202 which can be separated from each other, and a stack tray 240. The sheet ejected from the upper ejection roller 32a and the lower ejection roller 32b of the main body of the image forming apparatus to the staple stacker 200 is fed by the inlet rollers 201 and aligned by the paddle 221 and the jogger 222. After the sheet is stapled with the stapler 220, the sheet falls down from the jogger 222 and is loaded on the stack tray 240.

A front rail 243a and a rear rail 243b which are longer than the rails 43a and 43b provided in the ejection tray 40 described above are provided on the front side and the rear side of the staple stacker 200. The rails 243a and 243b of the staple stacker 200 and the rails 43a and 43b of ejection tray 40 have substantially identical configurations. The configurations of other components such as the flip-up member 47, the front and rear latches 48a and 48b, and the springs 91a and 91b are equal to those provided in the ejection tray 40.

Thus, in the staple stacker 200, a connection interface serving as connecting means to the main body of the image forming apparatus is equal to the interface of the standard ejection tray 40, so that the staple stacker 200 can be attached to the main body of the image forming apparatus when the reverse procedure of the process in which the ejection tray 40 is detached is performed.

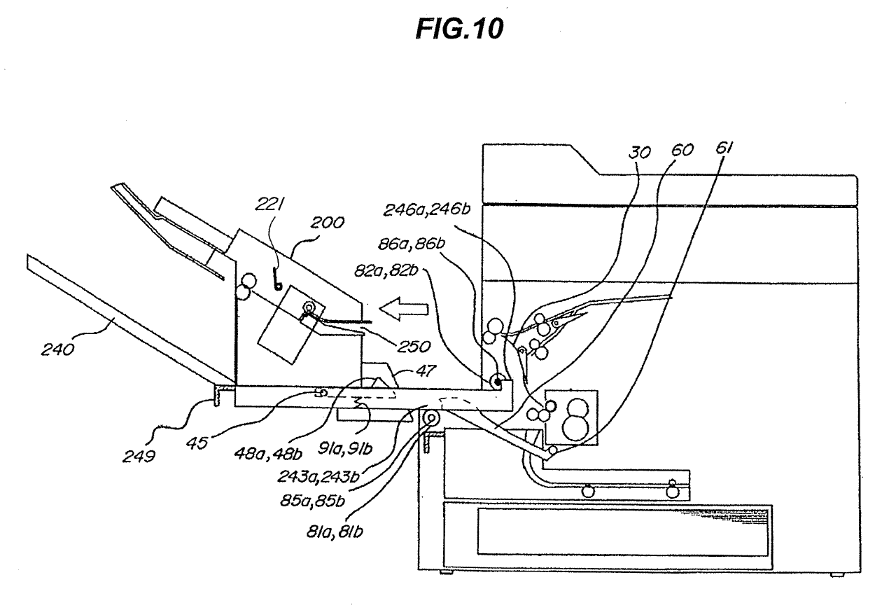

FIG. 10 is an explanatory view of a state in which the staple stacker 200 is drawn toward the left side in order to perform the jam disposal.

When the staple stacker 200 is drawn, similarly to the jam disposal of the ejection tray 40, the user puts user's hand on a handle 249 of the staple stacker 200 to draw the staple stacker 200 until stopper portions 246a and 246b abut on the shafts 86a and 86b.

Since the rails 243a and 243b provided in the staple stacker 200 are longer than the rails provided in the ejection tray 40, the amount of draw can be increased. When the staple stacker 200 is drawn, the second sheet conveying path 30 is also opened and closed in conjunction with the slide operation, so that the user can easily perform the jam disposal of the sheet. Further, the jam disposal can be performed in an inlet portion 250 of the staple stacker 200.

The staple stacker 200 can be detached from the main body of the apparatus in the same procedure as the ejection tray 40. When the staple stacker 200 is attached to the main body of the apparatus, similarly to the ejection tray 40, the front ends of the rails 243a and 243b of the staple stacker 200 are inserted into the openings 140a and 140b of the main body of the apparatus shown in FIG. 8, and the staple stacker 200 is inserted toward the direction of the arrow Y which is the attaching direction to the main body of the apparatus.

Although the staple stacker 200 has been described as an example of the post-processing device attached selectively to the image forming apparatus, it is also possible that the post-processing device is a mail bin sorter having a plurality of bins or a puncher having a punching function.

Even if the post-processing device is attached, similarly to the case in which the ejection tray 40 is attached, since the sheet ejection unit is retreated by the width L toward the inside of the main body from the sheet supply unit, the staple stacker 200 can overlap with the main body of the image forming apparatus by the retreated length L. Therefore, the width of the apparatus can be decreased. When the post-processing device becomes larger, this configuration is more effective in miniaturizing the apparatus.

As described above, the connecting configuration between the standard ejection tray 40 and the main body of the image forming apparatus 1 and the connecting configuration between the post-processing device and the main body of the image forming apparatus 1 are substantially unified, so that the post-processing device can be easily attached to the single image forming apparatus. Further, with reference to the attachment and detachment operations, the same operation sense can be held.

Since the load of the drawable post-processing device 200 is supported by the frame portions having the sufficient strength, even if the post-processing device has the heavy weight, the position which receives the load becomes optimum and the sufficient strength is obtained.

The lower rollers 81a and 81b and the upper rollers 82a and 82b, which serve as supporting means for slidably supporting the ejection tray 40 with respect to the main body of the image forming apparatus 1, support the post-processing device when the post-processing device is attached to the main body of the image forming apparatus 1. Since the common supporting means supports the ejection tray and the post-processing device which are selectively attached to the main body of the image forming apparatus 1, it is not necessary that the individual supporting means for supporting each of the ejection tray and the post-processing device is provided in the main body of the image forming apparatus. Therefore, cost can be suppressed.

The configuration, in which the rod-shaped rails are provided in the ejection tray 40 or the staple stacker 200 which is attached to or detached from the main body of the apparatus and the rollers are provided on the main body side of the apparatus, has been shown as an example of the configuration which slidably supports the ejection tray or the staple stacker 200 in the above-described embodiment. However, it is also possible that the guide rails are provided in the rod-shaped guide rails provided in the ejection tray 40 or the staple stacker 200 and a support plate which slidably supports the ejection tray 40 or the staple stacker 200 by guiding the guide rollers is provided on the main body side of the apparatus. It is also possible that the rollers are not used, the support plates are provided in each of the ejection tray 40 or the staple stacker 200 and the main body of the apparatus, and the ejection tray 40 or the staple stacker 200 is slidably supported by the support plate on the main body side of the apparatus.

It is also possible that a slidably moving member is provided in the main body of the apparatus and the ejection tray or the post-processing device is attached to the moving member. The moving member and the ejection tray or the post-processing device can be connected, for example, in such a manner that a hook provided in the ejection tray or the post-processing device is hooked on a pin provided in the moving member. In this case, it is possible that the connecting configuration between the ejection tray and the main body of the apparatus is equal to the connecting configuration between the post-processing device and the main body of the apparatus.

[Jam Disposal of Double-sided Conveying Path]

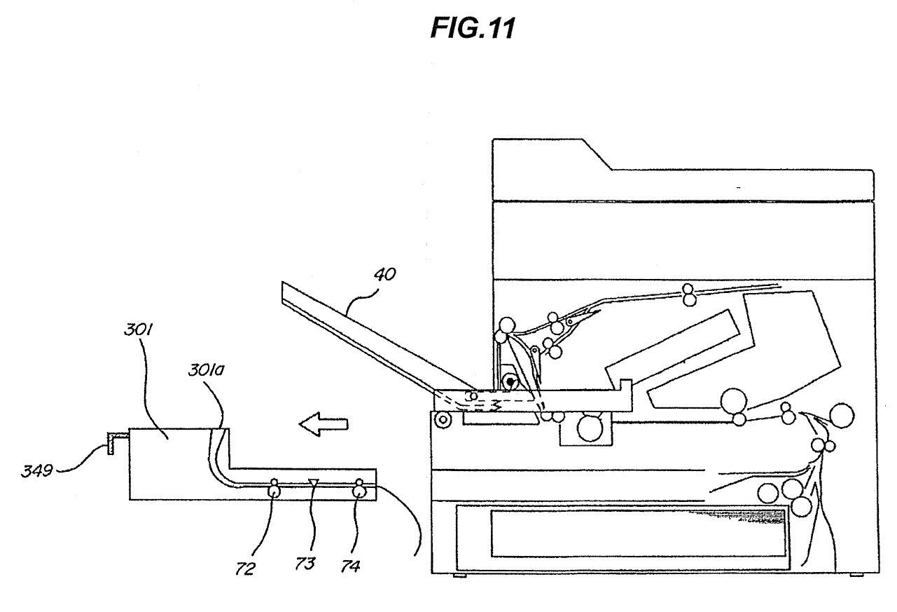

In addition to the jam disposal of the second sheet conveying path serving as the sheet path to the sheet ejection unit, the configuration which performs the jam disposal of the double-sided conveying path 71 will be described below referring to FIG. 11. The double-sided conveying path 71 is one in which the sheet is fed to the image forming unit again in order to form the image on the backside of the sheet in which the image formation on the first surface has been finished. The double-sided conveying path 71 is arranged in a double-sided conveying unit 301 which is slidably provided with respect to the main body of the image forming apparatus 1. When the sheet S is jammed in the double-sided conveying path 71 or the conveying path near the double-sided conveying path 71, the jam disposal is performed by drawing the double-sided conveying unit 301 which includes the double-sided conveying path 71, the pair of double-sided first conveying rollers 72, the pair of double-sided second conveying rollers 74, and the double-sided conveying sensor 73.

FIG. 11 is an explanatory view of a state in which the double-sided conveying unit has been drawn out.

The double-sided conveying unit 301 has a guide member (not shown) which is horizontally slidable in the image forming apparatus. As shown in FIG. 11, the double-sided conveying unit 301 is configured so as to be slidable in the same direction as the slide direction of the ejection tray 40.

In the jam disposal, as shown in FIG. 11, the user can put user's hand on a handle 349 provided at the end portion of the double-sided conveying unit 301 to draw the double-sided feed unit 301 toward the left side (arrow direction).

In the drawing operation, the double-sided conveying unit 301 can be perfectly detached from the main body of the image forming apparatus, and the jammed sheet can be removed from a sheet path 301a on the upper portion of the double-sided conveying unit 301 or a sheet path 301b on the right side.

After the jam disposal is finished, the double-sided conveying unit 301 can be attached by inserting the double-sided conveying unit 301 into the image forming apparatus.

According to the configuration, in the jam disposal, it is possible that the slide direction of the ejection tray 40 and the post-processing device is equal to the slide direction of the double-sided conveying unit 301. Therefore, the operability can be unified, and the user can easily perform the jam disposal.

In the embodiments, the image forming apparatus in which the sheet is fed to the image forming unit to form the image and the sheet is ejected to the sheet ejection unit after the image formation has been described as an example of the image processing apparatus. However, the invention can be also preferably applied to not only the image forming apparatus such as the printer and the copying machine but also the image reading apparatus such as the scanner.

Namely, in the image reading apparatus having an image reading unit as the image processing unit, the sheet feed configuration and the sheet ejection configuration which have been shown in the above-described embodiments can be used for the apparatus in which the sheet document is fed from the sheet supply unit to the image reading unit and the document is ejected to the sheet ejection unit after the reading.

As described above, since the sheet conveying path is opened and closed in conjunction with the slide movement of the ejection tray or the post-processing device in the invention, in opening the sheet conveying path, there is no fear that the sheet ejected to the ejection tray falls down from the ejection tray, and the user can easily perform the jam disposal or the like.

1-12. (canceled)

13. An image processing apparatus comprising:
an apparatus main body;
an image processing unit, which performs image processing to a sheet, provided in the apparatus main body;
a sheet guide member, which forms a sheet path though which the sheet passes, provided in the apparatus main body;
a post-processing device configured to perform a post-processing to the sheet guided by the sheet guide member; and
a device guiding unit, which slidably guides the post-processing device with respect to the apparatus main body, provided in the apparatus main body,
wherein the sheet guide member moves in conjunction with the slide movement of the post-processing device with respect to the apparatus main body.

14. An image processing apparatus according to claim 13,
wherein the sheet guide member moves so that the sheet path is opened in conjunction with the slide movement of the post-processing device in the direction in which the post-processing device are separated from the apparatus main body.

15. An image processing apparatus according to claim 13, wherein the sheet path is closed by moving the sheet guide member in conjunction with the slide movement of the post-processing device in the direction in which the post-processing device are attached to the apparatus main body.

16. An image processing apparatus according to claim 13, wherein the device guiding unit slidably supports the post-processing device, and wherein the device guiding unit supports rails included in the post-processing device, and wherein the device guiding unit includes upper rollers abutting on an upper side of the rails and lower rollers abutting on a lower side of the rails, and the upper rollers are provided on a downstream side of the lower rollers in an attachment direction of the post-processing device.

17. An image processing apparatus according to claim 13, wherein the sheet path has a first path which reverses a surface of the sheet after image processing to guide the sheet to the post-processing device and a second path which guides the sheet after image processing to the post-processing device, and
the second path is opened and closed in conjunction with the slide movement of the post-processing device with respect to the apparatus main body.

18. An image processing apparatus according to claim 13, further comprising an abutting portion provided on the post-processing device configured to abut on the sheet guide member,
wherein the sheet path is opened by moving the sheet guide member in conjunction with the slide movement of the post-processing device in the direction in which the post-processing device are separated from the apparatus main body, and
the sheet path is closed by moving the sheet guide member in conjunction with the slide movement of the post-processing device in the direction in which the post-processing device are attached to the apparatus main body.

19. An image processing apparatus comprising:
an apparatus main body;
an image processing unit, which performs image processing to a sheet, provided in the apparatus main body;
a sheet guide member, which forms a sheet path though which the sheet passes, provided in the apparatus main body;
a tray unit on which the sheets guided by the sheet guide member are stacked; and
a guiding unit, which slidably guides the tray unit with respect to the apparatus main body, provided in the apparatus main body,
wherein the sheet guide member moves in conjunction with the slide movement of the tray unit with respect to the apparatus main body.

20. An image processing apparatus according to claim 19,
wherein the sheet guide member moves so that the sheet path is opened in conjunction with the slide movement of the tray unit in the direction in which the tray unit are separated from the apparatus main body.

21. An image processing apparatus according to claim 19, wherein the sheet path is closed by moving the sheet guide member in conjunction with the slide movement of the tray unit in the direction in which the tray unit are attached to the apparatus main body.

22. An image processing apparatus according to claim 19, wherein the guide unit slidably supports the tray unit,
wherein the guide unit supports rails included in the tray unit, and
wherein the guide unit includes upper rollers abutting on an upper side of the rails and lower rollers abutting on a lower side of the rails, and the upper rollers are provided on a downstream side of the lower rollers in an attachment direction of the tray unit.

23. An image processing apparatus according to claim 19, wherein the sheet path has a first path which reverses a surface of the sheet after image processing to guide the sheet to the tray unit and a second path which guides the sheet after image processing to the tray unit, and
the second path is opened and closed in conjunction with the slide movement of the tray unit with respect to the apparatus main body.

24. An image processing apparatus according to claim 19, further comprising an abutting portion provided on the tray unit configured to abut on the sheet guide member,
wherein the sheet path is opened by moving the sheet guide member in conjunction with the slide movement of the tray unit in the direction in which the tray unit are separated from the apparatus main body, and
the sheet path is closed by moving the sheet guide member in conjunction with the slide movement of the tray unit in the direction in which the tray unit are attached to the apparatus main body.

25. An image processing apparatus according to claim 13, wherein the post-processing device has a sheet tray on which the sheets are stacked.

26. An image processing apparatus comprising:
an apparatus body to which either a tray unit on which sheets are stacked on or a post-processing device for performing post-processing to a sheet is attached,
an image processing unit:
a sheet guide member which guides the sheet to which the image processing is performed by the image processing unit;
a pair of ejection unit which ejects the sheet guided by the sheet guide member to the ejection tray or the post-processing device; and
a support unit configured to slidably support the tray unit when the tray unit is attached to a apparatus body and to slidably support the post processing device when the post processing device is attached to the apparatus body.

27. An image processing apparatus according to claim 26, wherein the support unit supports rails included in the tray unit and the post processing device.
